(19) United States
(12) Patent Application Publication
(10) Pub. No.: US 2025/0265454 A1
(43) Pub. Date: Aug. 21, 2025

(54) TECHNIQUES FOR COMPRESSING A MACHINE-LEARNING MODEL

(71) Applicant: NVIDIA CORPORATION, Santa Clara, CA (US)

(72) Inventor: Charbel SAKR, Milpitas, CA (US)

(21) Appl. No.: 18/795,079

(22) Filed: Aug. 5, 2024

Related U.S. Application Data
(60) Provisional application No. 63/555,815, filed on Feb. 20, 2024.

(51) Int. Cl. G06N 3/0495; G06F 17/16

(52) U.S. Cl. CPC G06N 3/0495; G06F 17/16

(57) ABSTRACT

Techniques for executing trained machine learning models comprise presenting input data as a first activation tensor to a first layer of a trained machine learning model, compressing the first activation tensor using a first projection matrix that corresponds to the first layer of the trained machine learning model to produce a compressed first activation tensor, generating a first output tensor by multiplying the compressed first activation tensor and a first pre-computed weight matrix that corresponds to the first layer of the trained machine learning model, presenting the first output tensor as a second activation tensor to a second layer of the trained machine learning model, compressing the second activation tensor using a second projection matrix to produce a compressed second activation tensor, generating a second output tensor by multiplying the compressed second activation tensor and a second pre-computed weight matrix, and generating output data based on the second output tensor.

### CROSS-REFERENCE TO RELATED APPLICATIONS

This application claims benefit of the United States Provisional Patent Application titled “TECHNIQUES FOR EIGEN STATIC PRINCIPAL ACTIVATION COMPONENT ESTIMATION,” filed Feb. 20, 2024, and having Ser. No. 63/555,815. The subject matter of this related application is hereby incorporated herein by reference.

### BACKGROUND

### Field of the Various Embodiments

The various embodiments relate generally to computer science and artificial intelligence and, more specifically, to techniques for compressing a machine-learning model.

### DESCRIPTION OF THE RELATED ART

Machine learning can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data. In turn, the discovered information can be used to guide decisions and/or perform actions related to the data and/or other similar data.

Machine learning models can be very large and require specialized resources to train and execute once trained. For example, some trained large language models (LLMs) can include billions of parameters. Accordingly, various compression techniques, such as quantization and pruning, have been developed to reduce the number of parameters and computations needed for LLMs and other large machine learning models. Quantization is oftentimes used to reduce the precision of the parameter values included in a machine learning model, which reduces the overall size of the model as well as computational complexity when training the model and executing the trained model. For example, converting parameter value precision from a 32-bit representation to an 8-bit representation reduces the overall computational complexity of the trained model, which allows the trained LLM model to execute faster and also run on resource-constrained devices. Pruning is oftentimes used to reduce the number of parameters included in a LLM model by systematically removing portions of the LLM model, such as weights, neurons, or layers, during training. Removing portions of the LLM model increases the data sparsity associated with the LLM model parameters and reduces computational complexity when executing the trained LLM model. When data sparsity is implemented in a structured way, the removal process focuses on the order and location of the portions of the LLM model being eliminated. When data sparsity is implemented in an unstructured way, the removal process focuses on eliminating portions of the LLM model that have the lowest impact on accuracy.

One drawback of using quantization techniques for LLM model compression is that quantization results in model data and the computations using model data being represented using fewer bits. Reducing the number of bits used for model data and for related computations usually reduces model accuracy as well. Another drawback of using quantization techniques for LLM model compression is that specialized hardware is oftentimes needed to execute models, where the model is represented using a reduced number of bits. One drawback of using pruning techniques for LLM model compression is that structured pruning does not preserve accuracy of the model, because parts of the model with important information are removed. Another drawback of using pruning techniques for LLM model compression is that with unstructured pruning techniques, parts of LLM model are removed in an unpredictable order, causing pruned models to have sparse structures, leading to irregular patterns of computation and memory access. Accordingly, efficient execution of pruned models on hardware is challenging and difficult since standard hardware is not optimized for computations with sparse structures.

As the forgoing illustrates, what is needed in the art are more effective ways to compress LLM models.

### SUMMARY

One embodiment of the present disclosure sets forth a computer-implemented method for executing trained machine learning models comprises presenting input data as a first activation tensor to a first layer of a trained machine learning model, compressing the first activation tensor using a first projection matrix that corresponds to the first layer of the trained machine learning model to produce a compressed first activation tensor, generating a first output tensor by multiplying the compressed first activation tensor and a first pre-computed weight matrix that corresponds to the first layer of the trained machine learning model, presenting the first output tensor as a second activation tensor to a second layer of the trained machine learning model, compressing the second activation tensor using a second projection matrix that corresponds to the second layer of the trained machine learning model to produce a compressed second activation tensor, generating a second output tensor by multiplying the compressed second activation tensor and a second pre-computed weight matrix that corresponds to the second layer of the trained machine learning model, and generating output data for the trained machine learning model based on the second output tensor.

Other embodiments of the present disclosure include, without limitation, one or more computer-readable media including instructions for performing one or more aspects of the disclosed techniques as well as one or more computing systems for performing one or more aspects of the disclosed techniques

At least one technical advantage of the disclosed techniques relative to the prior art is that the disclosed techniques perform compression on the activation tensors of a machine learning model. Activation tensors are known to exhibit many redundancies. Accordingly, the disclosed techniques provide better opportunities for dimensionality reduction. In addition, the compression operations enabled by the disclosed techniques can be executed on any processor and do not need specialized hardware. Further, the disclosed techniques do not need any optimizations at run time, thereby facilitating overall execution efficiency. In addition, the disclosed techniques reduce the computational cost of inferencing using a machine learning model. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 illustrates a block diagram of the activation compressor in FIG. 1, according to various embodiments;

FIG. 3 illustrates computations of a compressed activation tensor, according to various embodiments;

FIGS. 4A and 4B are a flow diagram of method steps for compressing a trained LLM model, according to various embodiments;

FIG. 5 illustrates an application in more detail, according to various embodiments;

FIG. 6 illustrates computations of a compressed activation tensor during inferencing, according to various embodiments;

FIG. 7 is a flow diagram of method steps for compressing and executing retrained LLM model, according to various embodiments;

FIG. 8 is a more detailed illustration of compression server of FIG. 1, according to the various embodiments; and

FIG. 9 is a more detailed illustration of computing device of FIG. 1, according to the various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

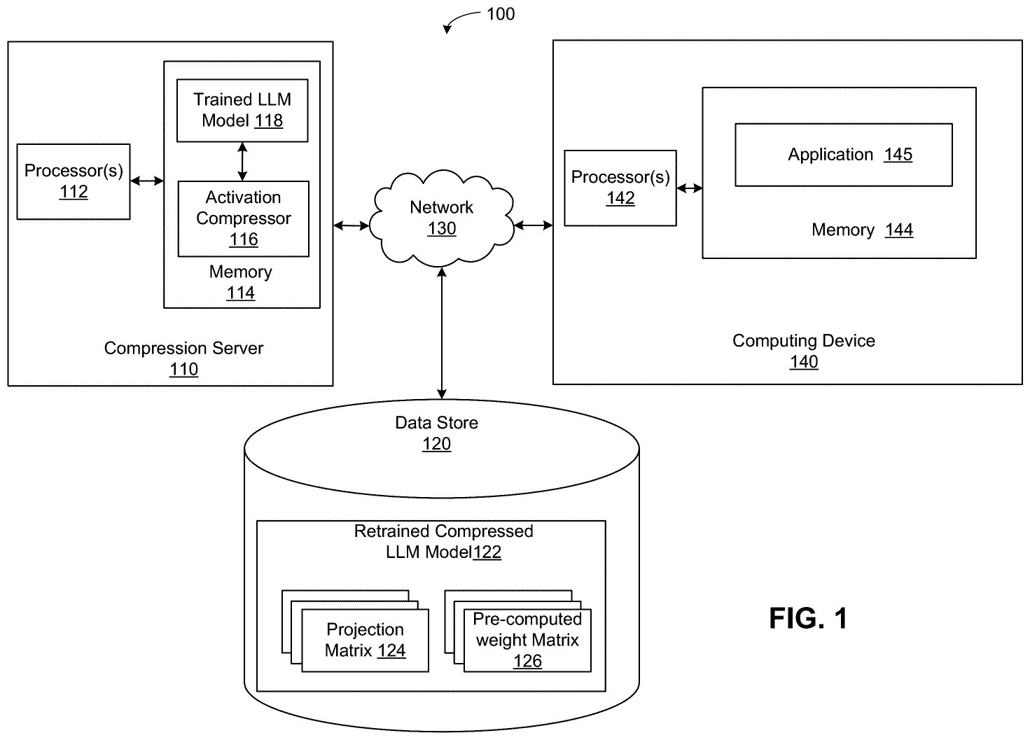

FIG. 1 illustrates a block diagram of a computer-based system 100 configured to implement one or more aspects of the various embodiments. As shown, system 100 includes, without limitation, a compression server 110, a data store 120, a network 130, and a computing device 140. Compression server 110 includes, without limitation, processor(s) 112 and a system memory 114. Memory 114 includes, without limitation, an activation compressor 116 and a trained LLM model 118. Computing device 140 includes, without limitation, processor(s) 142 and memory 144. Memory 144 includes, without limitation, an application 145. Data store 120 includes, without limitation, a retrained compressed LLM model 122, including one or more projection matrices 124 and one or more pre-computed weight matrices 126.

Compression server 110 shown herein is for illustrative purposes only, and variations and modifications are possible without departing from the scope of the present disclosure. For example, the number and types of processors 112, the number and types of system memories 114, and/or the number of applications included in the system memory 114 can be modified as desired. Further, the connection topology between the various units in FIG. 1 can be modified as desired. In some embodiments, any combination of the processor(s) 112 and the system memory 114 can be included in and/or replaced with any type of virtual computing system, distributed computing system, and/or cloud computing environment, such as a public, private, or a hybrid cloud system.

Processor(s) 112 receive user input from input devices, such as a keyboard or a mouse. Processor(s) 112 can be any technically feasible form of processing device configured to process data and execute program code. For example, any of processor(s) 112 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 112, or any combination of these different processors, such as a CPU working in cooperation with a one or more GPUs. In various embodiments, the one or more GPU(s) perform parallel processing task, such as matrix multiplications and/or the like in LLM model computations. Processor(s) 112 can also receive user input from input devices, such as a keyboard or a mouse and generate output on one or more displays.

System memory 114 of compression server 110 stores content, such as software applications and data, for use by processor(s) 112. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace system memory 114. The storage can include any number and type of external memories that are accessible to processor(s) 112. For example, and without limitation, the storage can include a Secure Digital Card, an external Flash memory, a portable compact disc read-only memory (CD-ROM), an optical storage device, a magnetic storage device, and/or any suitable combination of the foregoing.

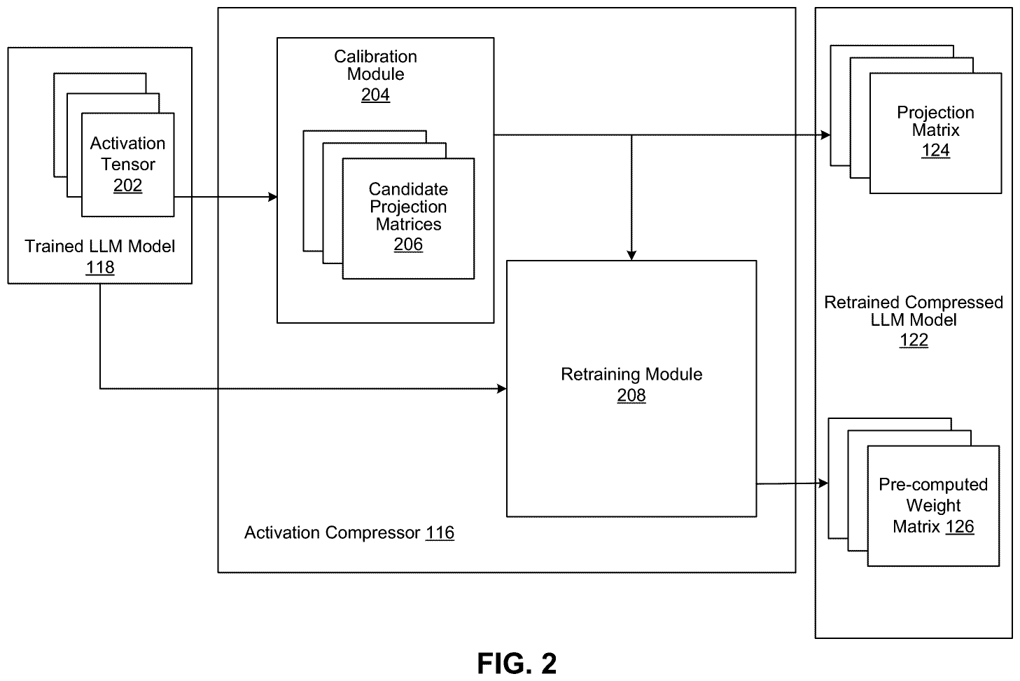

Activation compressor 116 is configured to compress trained LLM model 118 by compressing the activation tensors of trained LLM model 118. Activation compressor 116 compresses trained LLM model 118 by generating retrained compressed LLM model 122, which includes projection matrices 124 and pre-computed weight matrices 126. Activation compressor 116 then stores retrained compressed LLM model 122, including projection matrices 124 and pre-computed weight matrices 126, in data store 120. The retrained compressed LLM model 122, projection matrices 124, and pre-computed weight matrices 126 can then be used in any suitable application, such as application 145 executing on computing device 140. In some embodiments, activation compressor 116 compresses trained LLM model 118 or any number of trained LLM models. In some embodiments, during compression of trained LLM model 118 activation compressor 116 uses different fidelity metrics to determine projection matrices 124 that compress trained LLM model 118. Trained LLM model 118 can be any type of technically feasible machine learning model. For example, in various embodiments, trained LLM model 118 can be a transformer based LLM model, such as a generative pre-trained transformer (GPT), with any suitable architecture. The operations performed by activation compressor 116 to compress trained LLM model 118 are described in greater detail below in conjunction with FIGS. 2-4.

Data store 120 provides non-volatile storage for applications and data in compression server 110 and computing device 140. For example, and without limitation, training data, trained (or deployed) machine learning models and/or application data, including trained LLM model 118, retrained compressed LLM model 122, including projection matrices 124 and pre-computed weight matrices 126, can be stored in the data store 120. In some embodiments, data store 120 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 120 can be a network attached storage (NAS) and/or a storage area-network (SAN). Although shown as coupled to compression server 110 and computing device 140 via network 130, in various embodiments, compression server 110 or computing device 140 can include data store 120.

Network 130 includes any technically feasible type of communications network that allows data to be exchanged between compression server 110, computing device 140, data store 120 and external entities or devices, such as a web server or another networked computing device. For example, network 130 can include a wide area network (WAN), a local area network (LAN), a cellular network, a wireless (WiFi) network, and/or the Internet, among others.

Computing device 140 shown herein is for illustrative purposes only, and variations and modifications are possible without departing from the scope of the present disclosure. For example, the number and types of processors 142, the number and types of system memories 144, and/or the number of applications included in the system memory 144 can be modified as desired. Further, the connection topology between the various units in FIG. 1 can be modified as desired. In some embodiments, any combination of the processor(s) 142 and/or the system memory 144 can be included in and/or replaced with any type of virtual computing system, distributed computing system, and/or cloud computing environment, such as a public, private, or a hybrid cloud system.

Processor(s) 142 receive user input from input devices, such as a keyboard or a mouse. Processor(s) 142 can be any technically feasible form of processing device configured to process data and execute program code. For example, any of processor(s) 142 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 142, or any combination of these different processors, such as a CPU working in cooperation with a one or more GPUs. In various embodiments, the one or more GPU(s) perform parallel processing task, such as matrix multiplications and/or the like in LLM model computations. Processor(s) 142 can also receive user input from input devices, such as a keyboard or a mouse and generate output on one or more displays.

Similar to memory 114 of compression server 110, memory 144 of computing device 140 stores content, such as software applications and data, for use by the processor(s) 142. The system memory 144 can be any type of memory capable of storing data and software applications, such as a RAM, ROM, EPROM, Flash ROM, or any suitable combination of the foregoing. In some embodiments, a storage (not shown) can supplement or replace the system memory 144. The storage can include any number and type of external memories that are accessible to processor 142. For example, and without limitation, the storage can include a Secure Digital Card, an external Flash memory, a portable CD-ROM, an optical storage device, a magnetic storage device, and/or any suitable combination of the foregoing.

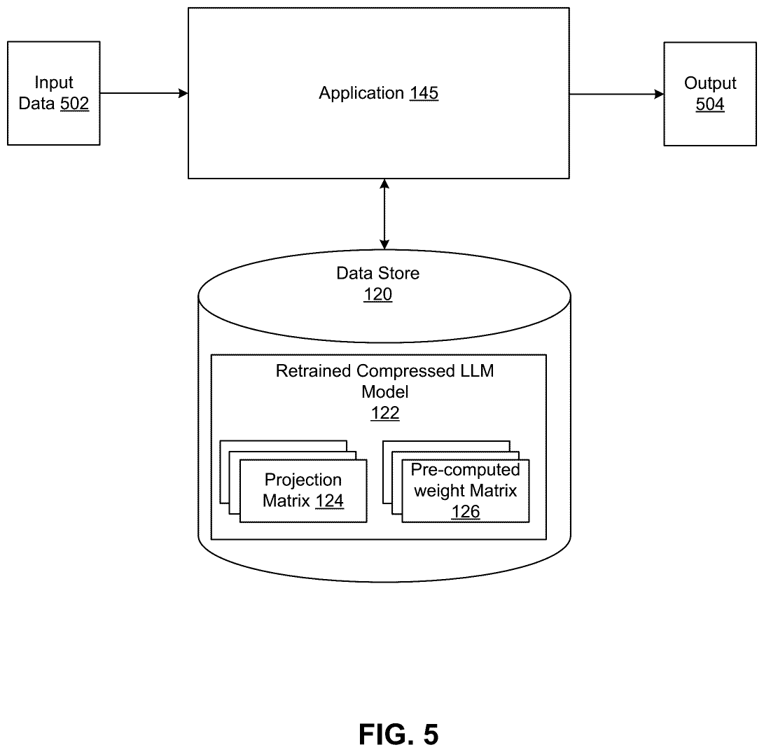

To perform inferencing, application 145 accesses retrained compressed LLM model 122, including the one or more projection matrices 124 and the one or more pre-computed weight matrices 126, computed by activation compressor 116 from data store 120. Application 145 then presents input data to retrained compressed LLM model 122 as an activation tensor for a first layer of retrained compressed LLM model 122. Application 145 then iteratively processes activation tensors layer by layer through retrained compressed LLM model 122 to generate an output. More specifically, for each activation tensor, application 145 multiplies, a respective projection matrix 124 and the respective activation tensor to generate a compressed activation tensor. Application 145 then multiplies a respective pre-computed weight matrix 126 and the compressed activation tensor to generate and, when appropriate further applies an activation function, to generate an output tensor for the respective layer of the retrained compressed LLM model 122. The output tensor for the respective layer then becomes the activation tensor for the next layer of retrained compressed LLM model 122. The output tensor of the last layer of retrained compressed LLM model 122 then becomes the output for the retrained compressed LLM model 122. As described for trained LLM model 118, retrained compressed LLM model 122 can also be any type of technically feasible machine learning model. For example, in various embodiments, retrained LLM model 122 can be a transformer based LLM model, such as a GPT, with any suitable architecture. The operations performed during inferencing are described in greater detail below in conjunction with FIG. 5-7.

### Compressing a Machine Learning Model

FIG. 2 illustrates a block diagram of activation compressor 116, according to various embodiments. As shown, activation compressor 116 includes, without limitation, a calibration module 204 and a retraining module 208. Calibration module 204 includes, without limitation, a plurality of candidate projection matrices 206.

Initially, trained LLM model 118 processes different batches of training data to determine one or more activation tensors 202 for each layer of trained LLM model 118. Each activation tensor 202 is a multi-dimensional array that represents the outputs of neurons in a corresponding layer of trained LLM model 118 after applying an activation function. In operation, activation compressor 116 uses trained LLM model 118 and one or more activation tensors 202 to generate retrained compressed LLM model 122, including projection matrices 124 and pre-computed weight matrices 126.

Calibration module 204 receives one or more activation tensors 202 and trained LLM model 118 and generates a respective projection matrix 124 for each activation tensor 202. For a given activation tensor 202, calibration module 204 performs a series of computations in order to determine respective projection matrix 124 to use when compressing the corresponding layer of trained LLM model 118. To help obtain an improved compression of trained LLM model 118, calibration module 204 separately analyzes each activation tensor 202 against a plurality of fidelity metrics. Examples of suitable fidelity metrics include, without limitation, mean squared error (MSE), normalized MSE, general matrix multiplications output-referred MSE (GO-MSE), network loss-referred MSE (NL-MSE), normalized GO-MSE, and normalized NL-MSE.

The operation of a layer of trained LLM model 118 with an uncompressed activation tensor 202 can be described using the matrix multiplication in equation 1.

$$Y = {W}^{T} X \qquad ( 1 )$$

where W is a weight matrix of size K×N and X is an input activation tensor of size K×M, such as activation tensor 202, and output activation tensor Y is of size N×M. Typically, K and N are defined by the LLM model topology and layer instance, which are commonly referred to as embedding or hidden size. For example, a Transformer-based LLM has four layers per block: query-key-value (QKV), projection (Proj), fully connected 1 (FC1), and fully connected 2 (FC2) layers. M is defined by stacking multiple instances of the training data in a two-dimensional (2D) matrix, so that all M instances of the training data can be processed in parallel. For example, the M instances of the training data could represent a batch or multiple batches of the training data.

Calibration module 204 compresses X in equation 1 by projecting X onto an orthonormal projection matrix P of size K×L, where K is the input activation tensor dimension and depends on the topology and layer instance of trained LLM model 118, and L is the intermediate dimension. Calibration module 204 can re-expand X using a transpose of P, such that X≈PP^{T}X. Equation 2 uses associativity of matrix multiplication to approximate the uncompressed activation tensor in equation 1 using P.

$$Y = {W}^{T} X \approx {W}^{T} {PP}^{T} X = {W}^{T} ( {PP}^{T} X ) = {( {P}^{T} W )}^{T} ( {P}^{T} X ) \qquad ( 2 )$$

where projection matrix P is not shared across different layers of trained LLM model 118 and each layer of trained LLM model 118 can have a respective projection matrix 124.

During inferencing, weight matrix W and projection matrix P in equation 2, are fixed but activation tensor X can change as X depends on the input of trained LLM model 118. The first term in equation 2, (P^{T}W)^{T}, can be pre-computed prior to the LLM model being used for inferencing, by multiplying the first term and the second term (P^{T}X) in equation 2, which is changing with the input. Because projection matrix P is of size K×L, with L<<K, and pre-computed matrix (P^{T}W)^{T} is of size L×N, with L<<N, where N is the size of each layer output that matches inputs of the next layer and depends on the topology and layer instance of the trained LLM model 118, fewer operations are used to compute Y in equation 2 compared to computing Y in equation 1.

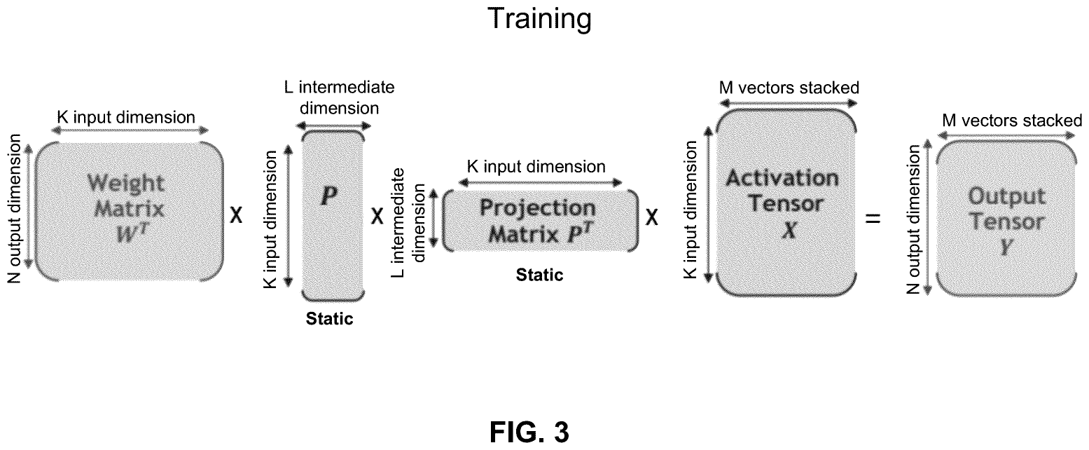

FIG. 3 illustrates computations of a compressed activation tensor 202, according to various embodiments. As shown, projection matrix P is used to compress activation tensor X. As described in FIG. 2, the output activation tensor Y with size of N×M is represented as W^{T}(PP^{T}X), where M is defined by stacking multiple instances of the training data in a two-dimensional (2D) matrix, so that all M instances of the training data can be processed in parallel. For example, the M instances of the training data could represent a batch or multiple batches of the training data.

Referring back to FIG. 2, in order to perform the compression, calibration module 204 uses projection matrix P to approximate activation tensor X as \tilde{X}=PP^{T}X. For a vector x∈X, the counterpart in \tilde{x}∈\tilde{X} is given by equation 3.

$$\tilde{x} = {\sum }_{i = 1}^{L} 〈 {p}_{i} , x 〉 {p}_{i} \qquad ( 3 )$$

where {pᵢ}ᵢ₌₁^{L} are the orthonormal column vectors of P, i.e., [symbol] pᵢ, pⱼ [symbol] =1_{{i==j}}, ∀i, j∈1 . . . . L. Compressing using projection matrix P introduces an approximation error because X≠PP^{T}X due to PP^{T}≠I_{K×K}, where I_{K×K} is the K×K identity matrix. In some embodiments, calibration module 204 uses different fidelity metrics to measure the approximation error. For each fidelity metric, calibration module 204 computes a respective candidate projection matrix P that minimizes the measured approximation error computed using that fidelity metric. For example, when calibration module 204 uses the MSE fidelity metric, the resulting approximation error is computed according to equation 4. And when calibration module 204 uses the NMSE fidelity metric, the resulting approximation error is computed according to equation 5.

$$E [ {‖ x - \tilde{x} ‖}^{2} ] \qquad ( 4 )$$

$$E [ {‖ x - \tilde{x} ‖}^{2} / {‖ x ‖}^{2} ] \qquad ( 5 )$$

In some embodiments, calibration module 204 can measure approximation error for the output activation tensor y∈Y. The output activation tensor y is defined as y= [symbol] w, x [symbol] for weight vector w∈W and activation vector x∈X. Calibration module 204 considers y to be the output activation tensor when activation tensor 202 is approximated by equation 2. Similarly, \tilde{y} is given by y= [symbol] w, \tilde{x} [symbol] , where \tilde{x} is defined in equation 3. Therefore, when calibration module 204 uses the GO-MSE fidelity metric, the resulting approximation error is computed according to equation 6. Alternatively, calibration module 204 can use upper bounds of the GO-MSE fidelity metric defined in equation 7 as a proxy to measure the output approximation error. In some embodiments, calibration module 204 can also measure the output approximation error for the normalized GO-MSE fidelity metric.

$$𝔼 [ {( y - \tilde{y} )}^{2} ] \qquad ( 6 )$$

$$𝔼 [ {( y - \tilde{y} )}^{2} ] \leq 2 𝔼 [ {‖ w ‖}^{2} \cdot {‖ x ‖}^{2} ] - 2 𝔼 [ 〈 w , x 〉 \cdot 〈 w , \tilde{x} 〉 ] \qquad ( 7 )$$

In some embodiments, calibration module 204 can measure approximation error for trained LLM model 118 loss. Given an input to trained LLM model 118, the output loss [symbol] can be defined by any loss function, such as a vocab cross-entropy. When an activation tensor 202 is approximated by equation 3, calibration module 204 considers [symbol] as the computed loss for trained LLM model 118 with the approximated activation tensor. When calibration module 204 uses the NL-MSE fidelity metric, the resulting approximation error is computed according to equation 8. In some embodiments, calibration module 204 can also measure loss approximation error for normalized NL-MSE fidelity metric. Alternatively, when calibration module 204 uses the upper bounds of NL-MSE fidelity metric, the resulting approximation error is computed according to equation 9 as a proxy to measure the loss approximation error.

$$𝔼 [ {( ℒ - \tilde{ℒ} )}^{2} ] \qquad ( 8 )$$

$$𝔼 [ {( ℒ - \tilde{ℒ} )}^{2} ] \leq 2 𝔼 [ {‖ {∇}_{x} ‖}^{2} \cdot {‖ x ‖}^{2} ] - 2 𝔼 [ 〈 {∇}_{x} , x 〉 \cdot 〈 {∇}_{x} , \tilde{x} 〉 ] \qquad ( 9 )$$

where a first order Taylor approximation on the loss function is used and the gradient with respect to vector x is denoted as ∇ₓ.

To minimize each of the described fidelity metrics, calibration module 204 computes a corresponding auto-correlation matrix. For example, for the MSE fidelity metric in equation 4, calibration module 204 uses a randomly selected activation vector x from activation tensor 202 to generate an activation auto-correlation matrix of size K×K as C_{X}= [symbol] [xx^{T}] where expectation is taken over activation vectors. The auto-correlation matrix can be empirically estimated by equation 10 using M activation vectors xi (collectively X) from activation tensor 202.

$$X = [ {x}_{1} \vert … \vert {x}_{M} ] ⇒ {XX}^{T} = [ {x}_{1} {x}_{1}^{T} + … + {x}_{M} {x}_{M}^{T} ] ⇒ {C}_{X} = {xx}^{T} / M \qquad ( 10 )$$

Alternatively, calibration module 204 can compute the auto-correlation corresponding to the NMSE fidelity metric in equation 5. In such a case, for an activation tensor X, the auto-correlation for NMSE fidelity metric is computed by equation 11.

$${\hat{C}}_{X} = 𝔼 [ ( x / ‖ x ‖ ) {( x / ‖ x ‖ )}^{T} ] \qquad ( 11 )$$

To minimize the approximation error, calibration module 204 can also compute the auto-correlation matrix for the upper bounds of the GO-MSE fidelity metric and the upper bounds of the NL-MSE fidelity metric defined in equations 7 and 9 and the upper bounds of the normalized GO-MSE fidelity metric, and the upper bounds of the normalized NL-MSE fidelity metric. In such cases, for a given activation tensor X, the auto-correlation matrix can be computed by equations 12-15 for the upper bounds of the GO-MSE fidelity metric, the upper bounds of the NL-MSE fidelity metric, the normalized upper bounds of the GO-MSE fidelity metric, and the normalized upper bounds of the NL-MSE fidelity metric, respectively.

$$C = 𝔼 [ {xx}^{T} {ww}^{T} + {ww}^{T} {xx}^{T} ] \qquad ( 12 )$$

$$C = 𝔼 [ {xx}^{T} {∇}_{x} {∇}_{x}^{T} + {∇}_{x} {∇}_{x}^{T} {xx}^{T} ] \qquad ( 13 )$$

$$\hat{C} = 𝔼 [ ( {xx}^{T} {ww}^{T} + {ww}^{T} {xx}^{T} ) / {‖ w ‖}^{2} \cdot {‖ x ‖}^{2} ] \qquad ( 14 )$$

$$\hat{C} = 𝔼 [ \frac{( {xx}^{T} {∇}_{x} {∇}_{x}^{T} + {∇}_{x} {∇}_{x}^{T} {xx}^{T}}{{‖ {∇}_{x} ‖}^{2} \cdot {‖ x ‖}^{2}} ] \qquad ( 15 )$$

For a given activation tensor 202, calibration module 204 selects a respective fidelity metric and computes the respective auto-correlation matrices using equation 10 for multiple batches of activation tensors 202. Accordingly, calibration module 204 uses M randomly selected activation vectors xi (collectively X), for each batch of activation tensors 202 among B batches that were randomly selected from activation tensors 202 to estimate a respective auto-correlation matrix for a given activation tensor 202. For example, the auto-correlation matrices for the MSE fidelity metric are computed using C_{X}^{(j)}=xᵢ^{(j)}xᵢ^{(j)T}/M, where superscript j denotes the batch index. Then, calibration module 204 estimates a respective auto-correlation matrix for the given activation tensor 202 by aggregating the computed auto-correlation matrices, e.g., averaging the computed auto-correlation matrices C_{X}=Σⱼ₌₁^{B}Cₓ^{(j)}/B.

After computing the estimated auto-correlation matrix C_{X}, calibration module 204 computes respective eigenvectors of the estimated auto-correlation matrix C_{X}. Calibration module 204 then generates the candidate projection matrix P for the activation tensor and fidelity metric pair using the eigenvectors. Because C_{X} is symmetric, positive, and semi-definite matrix having a real eigenvalue decomposition (EVD) C_{X}=VDV^{T} where V is an orthonormal matrix whose columns are eigenvectors, and D is a diagonal matrix containing the corresponding non-negative eigenvalues, assumed to be sorted in decreasing order. The eigenvector corresponding to the i^{th} largest eigenvalue is called i^{th} principal eigenvector. For an activation tensor 202 whose auto-correlation matrix has an eigenvalue decomposition given by Cx=VDV^{T}, the projection matrix P minimizing the fidelity metrics in equations 4, 5, 7, 9 is given by equation 16.

$$P = [ {v}_{1} \vert … \vert {v}_{L} ] \qquad ( 16 )$$

where vᵢ is the i^{th} principal eigenvector in V.

Calibration module 204 performs similar computations for each of the remaining fidelity metrics to generate a set of candidate projection matrices for a given activation tensor 202. More specifically, for the given activation tensor 202 and for a given fidelity metric, calibration module 204 repeats computing the respective autocorrelation matrices using equation 10 for multiple batches of activation tensors 202 randomly selected from activation tensors 202 computing an auto-correlation matrix for each batch, estimating an auto-correlation matrix by aggregating the computed auto-correlation matrices of different batches, computing an eigenvector decomposition for estimated auto-correlation matrix and generating a candidate projection matrix for the given fidelity metric.

For each activation tensor 202 and fidelity metric pair, calibration module 204 then multiplies respective candidate projection matrix 206 and the given activation tensor 202 to generate a compressed activation tensor. Calibration module 204 then multiplies the respective candidate projection matrix 206 and the weight matrix corresponding to the given activation tensor 202 to generate a respective partially compressed LLM model where only the layer associated with the activation tensor 202 is compressed and the remaining layers are not. Calibration module 204 then selects a projection matrix 124 from among respective candidate projection matrices 206 that corresponds to the respective partially compressed LLM model with the highest evaluated performance. To evaluate the performance, the respective partially compressed LLM model processes evaluation data to generate inferencing results. Evaluation data can be a subset of the training data, or any other data not presented to the trained LLM model 118. Calibration module 204 then uses a performance metric to evaluate the inferencing results. Calibration module 204 can use any metric to evaluate the performance of the partially compressed LLM model, such as the Perplexity score. Perplexity score measures a neural model's ability to make good predictions for new input patterns that were not included in the training data. Perplexity score is computed based on the respective partially compressed LLM model understanding of the text. The partially respective partially compressed LLM model assigns a probability to each possible next word in an output sentence. Then perplexity is calculated as the inverse of the geometric mean of the probabilities.

Calibration module 204 then repeats, for each of the remaining activation tensors 202, the steps to generate respective candidate projection matrices 206 for each of the fidelity metrics. Calibration module 204 then selects, for each of the remaining activation tensors 202, a respective projection matrix 124.

Retraining module 208 receives projection matrices 124 generated by calibration module 204 and trained LLM model 118. Retraining module 208 then uses activation tensors 202 and projection matrices 124 to finish generating retrained compressed LLM model 122, including pre-computed weight matrices 126. For each activation tensor 202, retraining module 208 multiplies the respective projection matrix 124 and the weight matrix corresponding to activation tensor 202. Retraining module 208 then retrains the compressed LLM model while keeping the respective projection matrices 124 static. During retraining, retraining module 208 modifies the weight matrices of the compressed LLM model to improve the performance of the compressed LLM model. Any performance metric can be used by retraining module 208, such as the Perplexity score. Retraining module 208 can use any feasible training technique to retrain the compressed LLM model, such as backpropagation. After completing the retraining of the compressed LLM model, retraining module 208 computes the respective pre-computed weight matrices 126 by multiplying selected projection matrices 124 and the weight matrices of retrained LLM model corresponding to each activation tensor 202. Retraining module 208 then stores retrained compressed LLM model 122, including projection matrices 124 and pre-computed weight matrices 126, into data store 120 to be used in any suitable application, such as application 145.

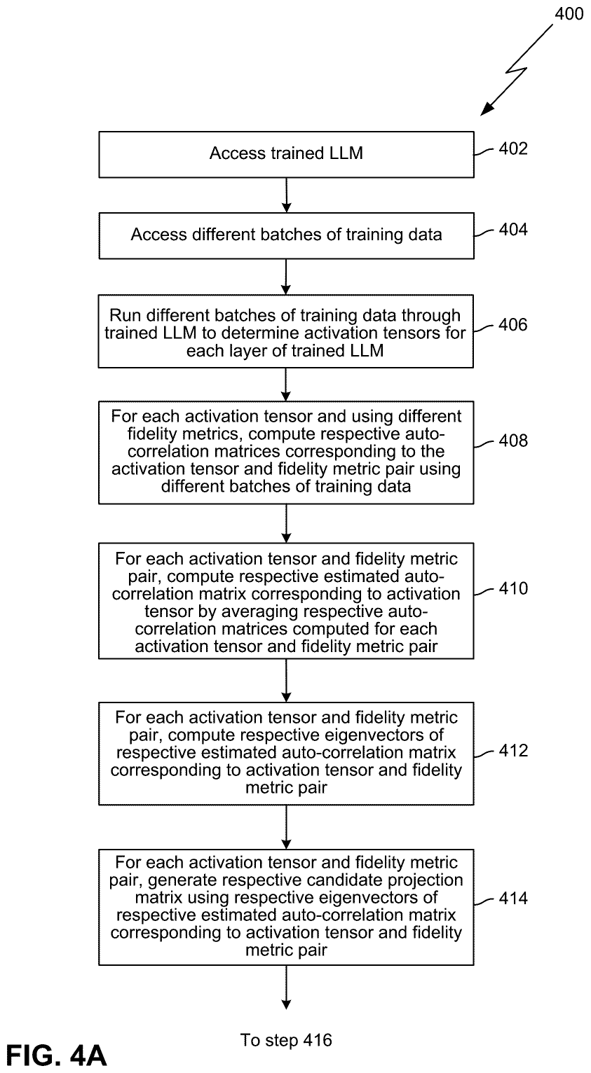

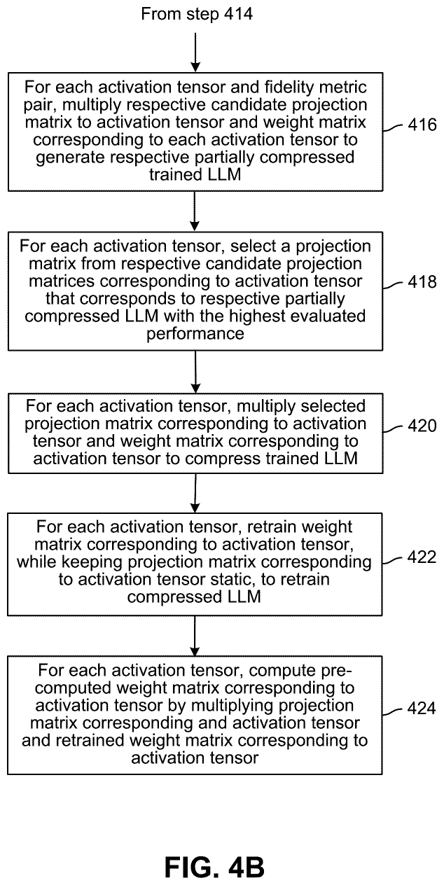

FIGS. 4A and 4B are a flow diagram of method steps for compressing trained LLM model 118, according to various embodiments. Although the method steps are described in conjunction with the systems of FIGS. 1-3, persons skilled in the art will understand that any system configured to perform the method steps in any order falls within the scope of the various embodiments.

As shown, a method 400 begins at step 402, where compression server 110 accesses trained LLM model 118. Trained LLM model 118 can be any type of machine learning model. For example, in various embodiments, trained LLM model 118 can be a transformer based LLM model, such as a GPT, with any suitable architecture. In some embodiments, compression server 110 can access any number of trained LLM models. Compression server 110 can receive trained LLM model 118 from any storage device, such as data store 120.

At step 404, compression server 110 accesses different batches of the training data. In some embodiments, compression server 110 can receive different batches of the training data from any storage device, such as data store 120.

At step 406, compression server 110 runs different batches of the training data through trained LLM model 118 to determine activation tensors 202 for each layer of trained LLM model 118.

At step 408, for each activation tensor 202 and using different fidelity metrics, calibration module 204 computes respective auto-correlation matrices corresponding to each activation tensor 202 and fidelity metric pair using different batches of the training data. Calibration module 204 separately analyzes each activation tensor 202 against a plurality of fidelity metrics to improve compression of trained LLM model 118. Examples of suitable fidelity metrics include, without limitation, MSE, NMSE, GO-MSE, NL-MSE, normalized GO-MSE, and normalized NL-MSE. To minimize each of the described fidelity metrics, calibration module 204 computes a corresponding auto-correlation matrix. For example, for the MSE fidelity metric in equation 4, calibration module 204 uses a randomly selected activation vector x from activation tensor 202 to generate an activation auto-correlation matrix of size K×K as Cx= [symbol] [xx^{T}], where expectation is taken over the activation vectors. The auto-correlation matrix can be empirically estimated by equation 10 using M activation vectors xi (collectively X) from activation tensor 202. Calibration module 204 then repeats computing the respective auto-correlation matrices for multiple batches of activation tensors 202. For example, the auto-correlation matrices for the MSE fidelity metric are computed using C(=xᵢ^{(j)}xᵢ^{(j)T}/M, where superscript j denotes batch index. Alternatively, calibration module 204 can compute the auto-correlation corresponding to the NMSE fidelity metric in equation 5. In such a case, for an activation tensor X, the auto-correlation for NMSE fidelity metric is computed by equation 11. To minimize the approximation error, calibration module 204 can also compute the auto-correlation matrix for the upper bounds of the GO-MSE fidelity metric and the upper bounds of the NL-MSE fidelity metric defined in equations 7 and 9 and the upper bounds of the normalized GO-MSE fidelity metric, and the upper bounds of the normalized NL-MSE fidelity metric. In such cases, for a given activation tensor X, the auto-correlation matrix can be computed by equations 12-15 for the upper bounds of the GO-MSE fidelity metric, the upper bounds of the NL-MSE fidelity metric, the normalized upper bounds of the GO-MSE fidelity metric, and the normalized upper bounds of the NL-MSE fidelity metric, respectively. Calibration module 204 performs similar computations for each of the remaining activation tensor 202 and fidelity metric pairs to compute a set of respective auto-correlation matrices for a given activation tensor 202 and fidelity metric pair.

At step 410, for each activation tensor 202 and fidelity metric pair, calibration module 204 computes a respective estimated auto-correlation matrix corresponding to activation tensor 202 by averaging the respective auto-correlation matrices computed for each activation tensor 202 and fidelity metric pair. Calibration module 204 estimates a respective auto-correlation matrix for the given activation tensor 202 and a given fidelity metric by aggregating the computed auto-correlation matrices, e.g., averaging the computed auto-correlation matrices for the selected B batches C_{X}=Σⱼ₌₁^{B}Cₓ^{(j)}/B. Calibration module 204 performs similar computations for each of the remaining activation tensor 202 and fidelity metric pairs to create a respective auto-correlation matrix estimate for a given activation tensor 202 and fidelity metric pair.

At step 412, for each activation tensor 202 and fidelity metric pair, calibration module 204 computes respective eigenvectors of respective estimated auto-correlation matrix corresponding to activation tensor 202 and fidelity metric pair. After computing the estimated auto-correlation matrix C_{X}, calibration module 204 computes respective eigenvectors of each estimated auto-correlation matrix C_{X}. Because C_{X} is symmetric, positive, and semi-definite matrix having a real eigenvalue decomposition (EVD) C_{X}=VDV^{T} where V is an orthonormal matrix whose columns are eigenvectors, and D is a diagonal matrix containing the corresponding non-negative eigenvalues, assumed to be sorted in decreasing order. The eigenvector corresponding to the i^{th} largest eigenvalue is called i^{th} principal eigenvector. For an activation tensor 202 and fidelity metric pair whose auto-correlation matrix has an eigenvalue decomposition given by Cx=VDV^{T}, the eigenvectors minimizing the fidelity metrics in equations 4, 5, 7, 9 are [v₁|, . . . , |v_{L}], where vᵢ is the i^{th} principal eigenvector in V. Calibration module 204 performs similar computations for each of the activation tensor 202 and fidelity metric pairs to create a set of eigenvectors for each activation tensor 202 and fidelity metric pair.

At step 414, for each activation tensor 202 and using different fidelity metrics, calibration module 204 generates a respective candidate projection matrix using respective eigenvectors of the respective estimated auto-correlation matrix corresponding to activation tensor 202 and fidelity metric pair. For each activation tensor 202 and each respective fidelity metric, calibration module 204 uses the computed eigenvectors at step 412 to generate the respective candidate projection matrix P using equation 16. Calibration module 204 performs similar computations for each of the activation tensor 202 and fidelity metric pairs to create a candidate projection matrix for a given activation tensor 202 and fidelity metric pair.

At step 416, for each activation tensor 202 and using different fidelity metrics, calibration module 204 multiplies respective candidate projection matrix 206 and activation tensor 202 and the weight matrix corresponding to each activation tensor 202 to generate the respective partially compressed trained LLM model. Calibration module 204 performs similar computations for each of the activation tensor 202 and fidelity metric pairs to create a respective partially compressed trained LLM model for each activation tensor 202 and fidelity metric pair.

At step 418, for each activation tensor 202, calibration module 204 selects a projection matrix from the respective candidate projection matrices 206 corresponding to activation tensor 202 that corresponds to the respective partially compressed LLM model with the highest evaluated performance. To evaluate the performance, the respective partially compressed LLM model processes evaluation data to generate inferencing results. Evaluation data can be a subset of the training data, or any other data not presented to trained LLM model 118. Calibration module 204 then uses a performance metric to evaluate inferencing results. Calibration module 204 can use any metric to evaluate the performance of the partially compressed LLM model, such as the Perplexity score.

At step 420, for each activation tensor 202, retraining module 208 multiplies the selected projection matrix 124 corresponding to activation tensor 202 and the weight matrix corresponding to activation tensor 202 to compress trained LLM model 118 according to equation 2. Retraining module 208 performs similar computations for each of the activation tensors 202.

At step 422, for each activation tensor 202, retraining module 208 retrains the weight matrix corresponding to activation tensor 202, while keeping projection matrix 124 corresponding to activation tensor 202 static, to retrain the compressed LLM model. During retraining, retraining module 208 modifies the weight matrices of the compressed LLM model to improve the performance of the compressed LLM model. Any performance metric of loss function of retraining module 208 can be used by retraining module 208, such as the Perplexity score. Retraining module 208 can use any feasible training technique to retrain the compressed LLM model, such as backpropagation.

At step 424, for each activation tensor 202, retraining module 208 computes the pre-computed weight matrix 126 corresponding to activation tensor 202 by multiplying projection matrix 124 corresponding to activation tensor 202 and the retrained weight matrix corresponding to activation tensor 202. Retraining module 208 uses the first term in equation 2, P^{T}W, to compute each pre-computed weight matrix 126. In some embodiments, retraining module 208 stores retrained compressed LLM model 122, including projection matrices 124 and pre-computed weight matrices 126 in data store 120 to be used in any suitable application, such as application 145.

### Inferencing Using a Compressed a Machine Learning Model

FIG. 5 illustrates application 145 in more detail, according to various embodiments. In operation, application 145 receives input data 502 and performs inferencing to generate output 504. Input data 502 can be various forms of text and structured data, such as natural language text, code, tables, structured text, and/or the like. Output 504 can be any type of machine learning model output, such as natural language text, structured text, code, and/or the like.

Application 145 accesses retrained compressed LLM model 122, including the one or more projection matrices 124 and the one or more pre-computed weight matrices 126, from data store 120. To perform inferencing, application 145 presents input data 502 to retrained compressed LLM model 122 as an activation tensor X to the first layer of retrained compressed LLM model 122. Application 145 compresses activation tensor X using the projection matrix 124 for the first layer of retrained LLM model 122 by multiplying the projection matrix 124 and the activation tensor X. Application 145 then multiplies the pre-computed weight matrix 126 and the compressed activation tensor for the first layer according to equation 2 and then, when appropriate, further applies an activation function to generate an output tensor Y for the first layer of retrained compressed LLM model 122. Output tensor Y for the first layer then becomes the activation tensor X for the second layer. Application 145 then applies equation 2 and, when appropriate, an activation function to the activation tensor X for the second layer of retrained compressed LLM model 122 to generate an output tensor Y for the second layer. Application 145 repeats the process for each of the remaining layers of retrained compressed LLM model 122 until output 504 is generated by the final layer of retrained compressed LLM model 122.

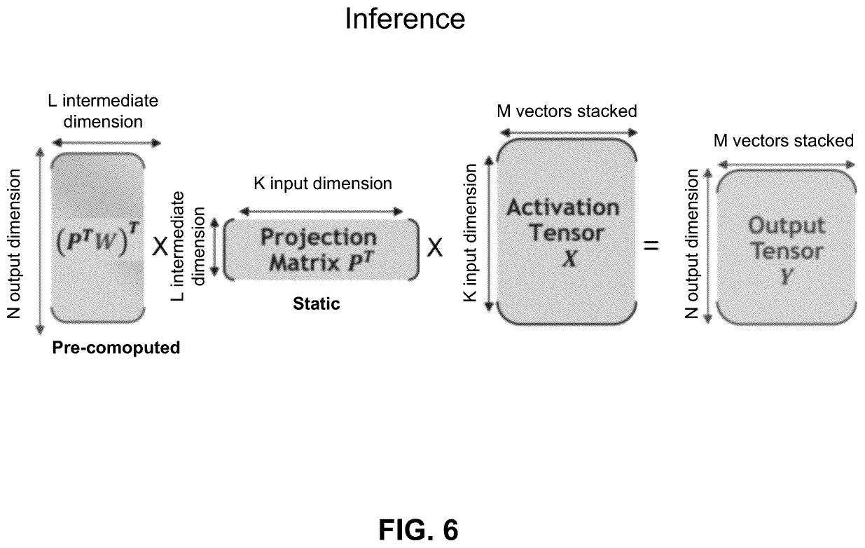

Although the inferencing process of application 145 is described above with respect to input data 502 having a single input vector, multiple input vectors M can be stacked to form an input matrix. For example, the M instances of input data 502 could represent a batch or multiple batches of input data 502. In such embodiments, the stacked input vectors of the input matrix can be processed in parallel using the same iterative application of equation 2 with the respective projection matrix 124 and respective pre-computed weight matrix 126 at each layer of retrained compressed LLM model 122 to generate output 504 as a matrix of M outputs. Exemplary operations performed by application 145 to compress the activation tensor X at each layer of retrained compressed LLM model 122 are shown below in conjunction with FIG. 6.

FIG. 6 illustrates computations of a respective activation tensor Y for a layer of retrained compressed LLM model 122 during inferencing, according to various embodiments. As shown, during inferencing, for a given layer of retrained compressed LLM model 122, pre-computed weight matrix 126 and projection matrix 124 are used to compress the activation tensor X. As described in equation 2, the output activation tensor Y with size of N×M is represented as (P^{T}W)^{T}(P^{T}X), where N is the size of each layer output that becomes the input of the next layer and depends on the topology and layer instance of retrained compressed LLM model 122, and M is the number of stacked instances of input data 502 In some embodiments, M can represent one input data 502. Projection matrix P in equation 2 has the size of K×L, where K is the input activation tensor dimension and depends on the topology and layer instance of trained LLM model 118, and L is the intermediate dimension. Because projection matrix P is of size K×L, and L<<K, fewer operations are used to compute Y in equation 2 compared to computing Y in equation 1. For example, if N=K, and L=K/4, then compressed retrained LLM model 504 can yield a 50 percent compression at inference time.

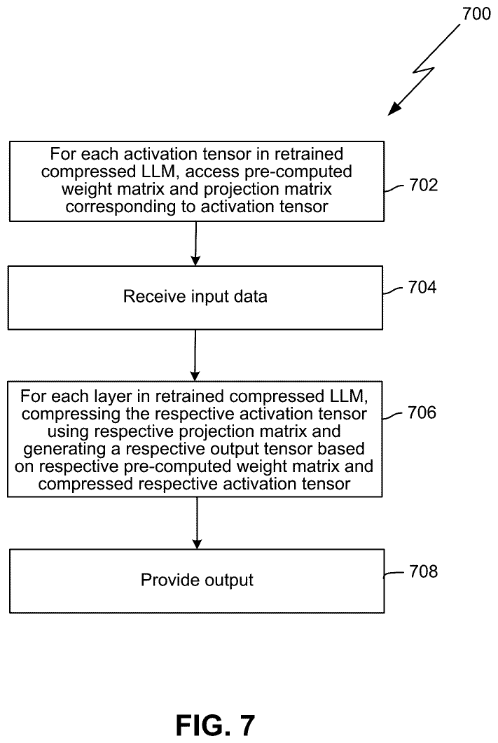

FIG. 7 is a flow diagram of method steps for compressing and executing retrained compressed LLM model 122, according to various embodiments. Although the method steps are described in conjunction with the systems of FIGS. 1-6, persons skilled in the art will understand that any system configured to perform the method steps in any order falls within the scope of the various embodiments

As shown, a method 700 begins at step 702, where for each activation tensor X in retrained compressed LLM model 122, application 145 accesses pre-computed weight matrix 126 and projection matrix 124 corresponding to activation tensor X. Application 145 initially accesses retrained compressed LLM model 122, projection matrix 124, and pre-computed weight matrix 126 corresponding to activation tensor X from data store 120. Retrained compressed LLM model 122 can be any type of machine learning model. For example, in various embodiments, retrained compressed LLM model 122 can be a transformer based LLM model, such as a GPT, with any suitable architecture. In some embodiments, application 145 can access any number of retrained compressed LLM models 122. Application 145 can receive retrained compressed LLM model 122, projection matrices 124, and pre-computed weight matrices 126 corresponding to activation tensor X from any storage device, such as data store 120.

At step 704, application 145 receives input data 502. Input data 502 can be various forms of text and structured data, such as natural language text, code, tables, structured text, and/or the like. In some scenarios input data 502 can be a single input vector or a stack of M input vectors. For example, the M instances of input data 502 could represent a batch or multiple batches of input data 502.

At step 706, for each layer in retrained compressed LLM model 122, application 145 compresses the respective activation tensor using the respective projection matrix 126 and generates a respective output tensor based on the respective pre-computed weight matrix 124 and the compressed respective activation tensor. Application 145 presents input data 502 to retrained compressed LLM model 122 as an activation tensor X to the first layer of retrained compressed LLM model 122. Application 145 compresses activation tensor X using the projection matrix 124 for the first layer of retrained compressed LLM model 122 by multiplying the projection matrix 124 for the first layer and activation tensor X. Application 145 then multiplies the pre-computed weight matrix 126 and the compressed activation tensor for the first layer and, when appropriate, further applies an activation function to generate an output tensor Y for the first layer of retrained compressed LLM model 122. Output tensor Y for the first layer then becomes the activation tensor X for the second layer. Application 145 then applies equation 2 and, when appropriate, an activation function to the activation tensor X for the second layer of retrained compressed LLM model 122 to generate an output tensor Y for the second layer. Application 145 then repeats the process for each of the remaining layers of retrained compressed LLM model 122 until output 504 is generated by the final layer of retrained compressed LLM model 122. When input data 502 includes a stack of M input data, the stacked input vectors of the input matrix can be processed in parallel using the same iterative application of equation 2 with the respective projection matrix 124 and respective pre-computed weight matrix 126 at each layer of retrained compressed LLM model 122 to generate output 504 as a matrix of M outputs.

At step 708, application 145 provides output 504. Output 504 is generated by the final layer of retrained compressed LLM model 122. Output 504 can be any type of machine learning model output, such as natural language text, structured text, code, and/or the like.

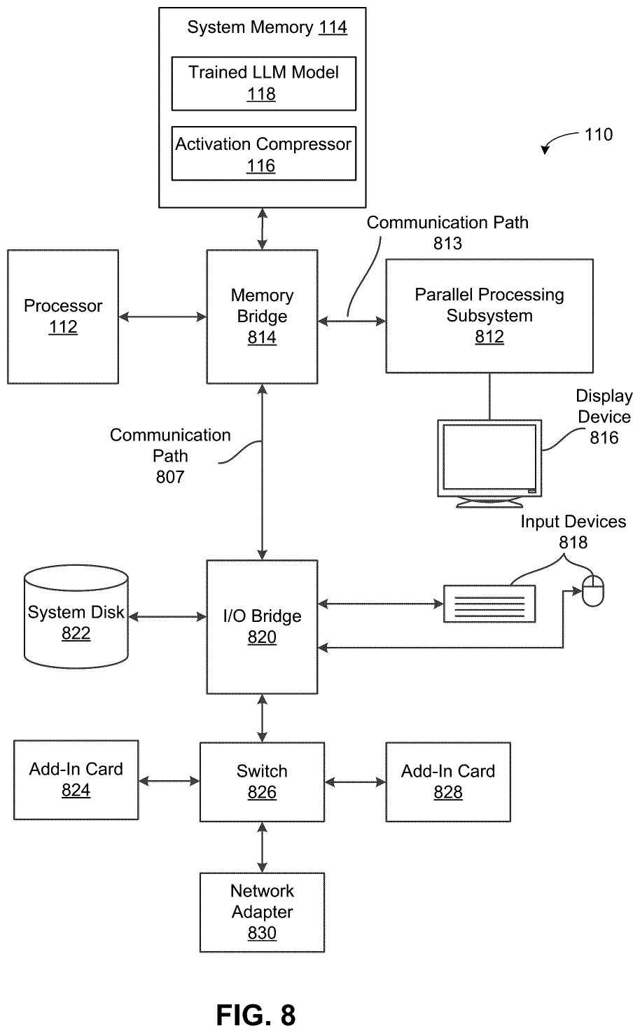

FIG. 8 is a more detailed illustration of compression server 110 of FIG. 1, according to the various embodiments. Compression server 110 can be any type of computing device, including, without limitation, a server machine, a server platform, a desktop machine, a laptop machine, a hand-held/mobile device, a digital kiosk, an in-vehicle infotainment system, and/or a wearable device. In some embodiments, compression server 110 is a server machine operating in a data center or a cloud computing environment that provides scalable computing resources as a service over a network.

As shown, the compression server 110 includes, without limitation, processor(s) 112 and system memory(ies) 114 coupled to a parallel processing subsystem 812 via a memory bridge 814 and a communication path 813. Memory bridge 814 is further coupled to an I/O (input/output) bridge 820 via a communication path 807, and I/O bridge 820 is, in turn, coupled to a switch 826.

In various embodiments, I/O bridge 820 is configured to receive user input information from optional input devices 818, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, compression server 110 is a server machine in a cloud computing environment. In such embodiments, compression server 110 does not include input devices 818, but can receive equivalent input information by receiving commands (e.g., responsive to one or more inputs from a remote computing device) in the form of messages transmitted over a network and received via the network adapter 830. In some embodiments, switch 826 is configured to provide connections between I/O bridge 820 and other components of compression server 110, such as a network adapter 830 and various add-in cards 824 and 828.

In some embodiments, I/O bridge 820 is coupled to a system disk 822 that is configured to store content and applications and data for use by processor(s) 112 and parallel processing subsystem 812. In one embodiment, system disk 822 provides non-volatile storage for applications and data and can include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, can be connected to I/O bridge 820 as well.

In various embodiments, memory bridge 814 is a Northbridge chip, and I/O bridge 820 is a Southbridge chip. In addition, communication paths 807 and 813, as well as other communication paths within compression server 110, can be implemented using any technically suitable protocols, including, without limitation, AGP (Accelerated Graphics Port), HyperTransport, or any other bus or point-to-point communication protocol known in the art.

In some embodiments, parallel processing subsystem 812 comprises a graphics subsystem that delivers pixels to an optional display device 816 that can be any conventional cathode ray tube, liquid crystal display, light-emitting diode display, and/or the like. In such embodiments, the parallel processing subsystem 812 incorporates circuitry optimized for graphics and video processing, including, for example, video output circuitry. Such circuitry can be incorporated across one or more parallel processing units (PPUs), also referred to herein as parallel processors, included within the parallel processing subsystem 812.

In some embodiments, the parallel processing subsystem 812 incorporates circuitry optimized (e.g., that undergoes optimization) for general purpose and/or compute processing. Again, such circuitry can be incorporated across one or more PPUs included within parallel processing subsystem 812 that are configured to perform such general purpose and/or compute operations. In yet other embodiments, the one or more PPUs included within parallel processing subsystem 812 is configured to perform graphics processing, general purpose processing, and/or compute processing operations. Memory 114 includes at least one device driver configured to manage the processing operations of the one or more PPUs within parallel processing subsystem 812. Illustratively, memory 114 includes, without limitation, activation compressor 116 and trained LLM model 118.

In various embodiments, parallel processing subsystem 812 is integrated with one or more of the other elements of FIG. 8 to form a single system. For example, parallel processing subsystem 812 can be integrated with processor 112 and other connection circuitry on a single chip to form a system on a chip (SoC).

In some embodiments, communication path 813 is a PCI Express link, in which dedicated lanes are allocated to each PPU. Other communication paths may also be used. The PPU advantageously implements a highly parallel processing architecture, and the PPU may be provided with any amount of local parallel processing memory(PP memory).

It will be appreciated that the system shown herein is illustrative and that variations and modifications are possible. The connection topology, including the number and arrangement of bridges, the number of processors 112, and the number of parallel processing subsystems 812, can be modified as desired. For example, in some embodiments, system memory 114 is connected to the processor(s) 112 directly rather than through memory bridge 814, and other devices communicate with system memory 114 via memory bridge 814 and processor 112. In other embodiments, parallel processing subsystem 812 is connected to I/O bridge 820 or directly to processor 112, rather than to memory bridge 814. In still other embodiments, I/O bridge 820 and memory bridge 814 are integrated into a single chip instead of existing as one or more discrete devices. In certain embodiments, one or more components shown in FIG. 8 may not be present. For example, switch 826 could be eliminated, and network adapter 830 and add-in cards 824, 828 would connect directly to I/O bridge 820. Lastly, in certain embodiments, one or more components shown in FIG. 8 are implemented as virtualized resources in a virtual computing environment, such as a cloud computing environment. In particular, the parallel processing subsystem 812 can be implemented as a virtualized parallel processing subsystem in at least one embodiment. For example, the parallel processing subsystem 812 can be implemented as a virtual graphics processing unit(s) (vGPU(s)) that renders graphics on a virtual machine(s) (VM(s)) executing on a server machine(s) whose GPU(s) and other physical resources are shared across one or more VMs.

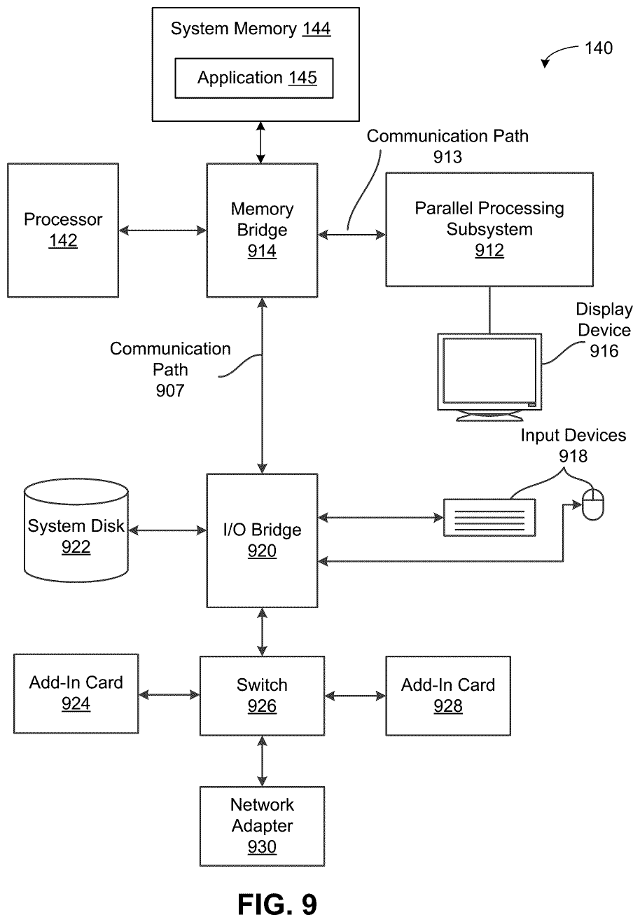

FIG. 9 is a more detailed illustration of computing device 140 of FIG. 1, according to the various embodiments. Computing device 140 can be any type of computing device, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network.

As shown, computing device 140 includes, without limitation, processor(s) 142 and system memory(ies) 144 coupled to a parallel processing subsystem 912 via a memory bridge 914 and a communication path 913. Memory bridge 914 is further coupled to an I/O (input/output) bridge 920 via a communication path 907, and I/O bridge 920 is, in turn, coupled to a switch 926.

In various embodiments, I/O bridge 920 is configured to receive user input information from optional input devices 918, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, computing device 140 is a server machine in a cloud computing environment. In such embodiments, computing device 140 does not include input devices 918, but can receive equivalent input information by receiving commands (e.g., responsive to one or more inputs from a remote computing device) in the form of messages transmitted over a network and received via the network adapter 930. In some embodiments, switch 926 is configured to provide connections between I/O bridge 920 and other components of computing device 140, such as a network adapter 930 and various add-in cards 924 and 928.

In some embodiments, I/O bridge 920 is coupled to a system disk 922 that is configured to store content and applications and data for use by processor(s) 142 and parallel processing subsystem 912. In one embodiment, system disk 922 provides non-volatile storage for applications and data and can include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, can be connected to I/O bridge 920 as well.

In various embodiments, memory bridge 914 is a Northbridge chip, and I/O bridge 920 is a Southbridge chip. In addition, communication paths 907 and 913, as well as other communication paths within computing device 140, can be implemented using any technically suitable protocols, including, without limitation, AGP (Accelerated Graphics Port), HyperTransport, or any other bus or point-to-point communication protocol known in the art.

In some embodiments, parallel processing subsystem 912 comprises a graphics subsystem that delivers pixels to an optional display device 916 that can be any conventional cathode ray tube, liquid crystal display, light-emitting diode display, and/or the like. In such embodiments, the parallel processing subsystem 912 incorporates circuitry optimized for graphics and video processing, including, for example, video output circuitry. Such circuitry can be incorporated across one or more parallel processing units (PPUs), also referred to herein as parallel processors, included within the parallel processing subsystem 912.

In some embodiments, the parallel processing subsystem 912 incorporates circuitry optimized (e.g., that undergoes optimization) for general purpose and/or compute processing. Again, such circuitry can be incorporated across one or more

PPUs included within parallel processing subsystem 912 that are configured to perform such general purpose and/or compute operations. In yet other embodiments, the one or more PPUs included within parallel processing subsystem 912 is configured to perform graphics processing, general purpose processing, and/or compute processing operations. Memory 144 includes at least one device driver configured to manage the processing operations of the one or more PPUs within parallel processing subsystem 912. Illustratively, memory 144 includes, without limitation, application 145.

In various embodiments, parallel processing subsystem 912 is integrated with one or more of the other elements of FIG. 9 to form a single system. For example, parallel processing subsystem 912 can be integrated with processor 142 and other connection circuitry on a single chip to form a system on a chip (SoC).

In some embodiments, communication path 913 is a PCI Express link, in which dedicated lanes are allocated to each PPU. Other communication paths may also be used. The PPU advantageously implements a highly parallel processing architecture, and the PPU may be provided with any amount of local parallel processing memory(PP memory).

It will be appreciated that the system shown herein is illustrative and that variations and modifications are possible. The connection topology, including the number and arrangement of bridges, the number of processors 142, and the number of parallel processing subsystems 912, can be modified as desired. For example, in some embodiments, system memory 144 is connected to the processor(s) 142 directly rather than through memory bridge 914, and other devices communicate with system memory 144 via memory bridge 914 and processor 142. In other embodiments, parallel processing subsystem 912 is connected to I/O bridge 920 or directly to processor 142, rather than to memory bridge 914. In still other embodiments, I/O bridge 920 and memory bridge 914 are integrated into a single chip instead of existing as one or more discrete devices. In certain embodiments, one or more components shown in FIG. 9 may not be present. For example, switch 926 could be eliminated, and network adapter 930 and add-in cards 924, 928 would connect directly to I/O bridge 920. Lastly, in certain embodiments, one or more components shown in FIG. 9 are implemented as virtualized resources in a virtual computing environment, such as a cloud computing environment. In particular, the parallel processing subsystem 912 can be implemented as a virtualized parallel processing subsystem in at least one embodiment. For example, the parallel processing subsystem 912 can be implemented as a virtual graphics processing unit(s) (vGPU(s)) that renders graphics on a virtual machine(s) (VM(s)) executing on a server machine(s) whose GPU(s) and other physical resources are shared across one or more VMs.

In sum, techniques have been described for compressing LLM models by compressing the activation tensors of the LLM models. The described techniques include, a trained LLM model processing different batches of training data to determine activation tensors for each layer of the trained LLM model. The described techniques further include applying different fidelity metrics for each activation tensor to determine projection matrices to compress the trained LLM model. For each activation tensor and fidelity metric pair, multiple steps are performed, a first step computes respective auto-correlation matrices for different batches of training data, a second step computes a respective estimated auto-correlation matrix by averaging the respective auto-correlation matrices, a third step computes respective eigenvectors of the respective estimated auto-correlation matrix, a fourth step generates a respective projection matrix using the respective eigenvectors, and a fifth step multiplies the respective projection matrix to the activation tensor and multiples the respective projection matrix and a weight matrix corresponding to the activation tensor to generate a respective partially compressed trained LLM model. Then, for each activation tensor, the techniques include selecting a projection matrix from the respective projection matrices that corresponds to the respective partially compressed LLM model with the highest evaluated performance, compressing the trained LLM model using the selected projection matrices, retraining the weight matrices of the compressed LLM model while keeping the projection matrix static to retrain the compressed LLM model, and computing a pre-computed weight matrices by multiplying the selected projection matrices and corresponding retrained weight matrices. During inferencing, the techniques include presenting input data as an activation tensor for a first layer of the retrained LLM model and then iteratively compressing the activation tensors and applying the pre-computed weight matrices layer by layer to generate an output. More specifically, for each respective activation tensor, a respective projection matrix and the respective activation tensor are multiplied to generate a respective compressed activation tensor, a respective pre-computed weight matrix and the respective compressed activation tensor are multiplied and, when appropriate, further applies an activation function to generate an output tensor that is provided as an activation tensor to a next layer. Inferencing proceeds iteratively through the layers of the retrained compressed LLM model until a last layer of the retrained compressed LLM model generates an output tensor that is provided as an output of the inferencing.

At least one technical advantage of the disclosed techniques relative to the prior art is that the disclosed techniques perform compression on the activation tensors of a machine learning model. Activation tensors are known to exhibit many redundancies. Accordingly, the disclosed techniques provide better opportunities for dimensionality reduction. In addition, the compression operations enabled by the disclosed techniques can be executed on any processor and do not need specialized hardware. Further, the disclosed techniques do not need any optimizations at run time, thereby facilitating overall execution efficiency. In addition, the disclosed techniques reduce the computational cost of inferencing using a machine learning model. These technical advantages represent one or more technological improvements over prior art approaches.
1. In some embodiments, a computer-implemented method for executing trained machine learning models comprises presenting input data as a first activation tensor to a first layer of a trained machine learning model, compressing the first activation tensor using a first projection matrix that corresponds to the first layer of the trained machine learning model to produce a compressed first activation tensor, generating a first output tensor by multiplying the compressed first activation tensor and a first pre-computed weight matrix that corresponds to the first layer of the trained machine learning model, presenting the first output tensor as a second activation tensor to a second layer of the trained machine learning model, compressing the second activation tensor using a second projection matrix that corresponds to the second layer of the trained machine learning model to produce a compressed second activation tensor, generating a second output tensor by multiplying the compressed second activation tensor and a second pre-computed weight matrix that corresponds to the second layer of the trained machine learning model, and generating output data for the trained machine learning model based on the second output tensor.
2. The computer-implemented method of clause 1, wherein the trained machine learning model comprises a retrained compressed machine learning model.
3. The computer-implemented method of clauses 1 or 2, wherein the retrained compressed machine learning model is retrained by at least retraining a weight matrix corresponding to a first activation tensor associated with the trained machine learning model while keeping a projection matrix corresponding to the first activation tensor static.
4. The computer-implemented method of any of clauses 1-3, wherein the trained machine learning model comprises N layers, and further comprising presenting an output tensor generated using an Nth-1 layer included in the trained machine learning model as an activation tensor to the Nth layer included in the machine learning model, compressing the activation tensor using a projection matrix that corresponds to the Nth layer of the trained machine learning model to produce a compressed activation tensor, and generating an output tensor by multiplying the compressed activation tensor and a pre-computed weight matrix that corresponds to the Nth layer of the trained machine learning model, wherein the output tensor comprises the output data generated for the trained machine learning model.
5. The computer-implemented method of any of clauses 1-4, wherein the output data generated for the trained machine learning model comprises natural language text, structured text, or computer code.
6. The computer-implemented method of any of clauses 1-5, wherein the first projection matrix, the second projection matrix, the first pre-computed weight matrix, and the second pre-computed weight matrix are accessible from a data store.
7. The computer-implemented method of any of clauses 1-6, wherein the first pre-computed weight matrix is computed by multiplying the first projection matrix and a retrained corresponding weight matrix.
8. The computer-implemented method of any of clauses 1-7, wherein the first projection matrix is generated based on a plurality of principal eigenvalues derived from an estimated autocorrelation matrix.
9. The computer-implemented method of any of clauses 1-8, wherein the estimated autocorrelation matrix is computed by averaging a plurality of autocorrelation matrices.
10. The computer-implemented method of any of clauses 1-9, wherein compressing the first activation tensor comprises multiplying a transpose of the first projection matrix and the first activation tensor, and wherein multiplying the compressed first activation tensor and the first pre-computed weight matrix comprises multiplying the transpose of the first projection matrix and the first pre-computed weight matrix to generate an intermediate matrix, and multiplying a transpose of the first intermediate matrix and the compressed first activation tensor.
11. In some embodiments, one or more non-transitory, computer-readable media include instructions that, when executed by one or more processors, cause the one or more processors to perform the steps of presenting input data as a first activation tensor to a first layer of a trained machine learning model, compressing the first activation tensor using a first projection matrix that corresponds to the first layer of the trained machine learning model to produce a compressed first activation tensor, generating a first output tensor by multiplying the compressed first activation tensor and a first pre-computed weight matrix that corresponds to the first layer of the trained machine learning model, presenting the first output tensor as a second activation tensor to a second layer of the trained machine learning model, compressing the second activation tensor using a second projection matrix that corresponds to the second layer of the trained machine learning model to produce a compressed second activation tensor, generating a second output tensor by multiplying the compressed second activation tensor and a second pre-computed weight matrix that corresponds to the second layer of the trained machine learning model, and generating output data for the trained machine learning model based on the second output tensor.
12. The one or more non-transitory, computer-readable media of clause 11, wherein the trained machine learning model comprises a retrained compressed machine learning model, and wherein the retrained compressed machine learning model is retrained by at least retraining a weight matrix corresponding to a first activation tensor associated with the trained machine learning model while keeping a projection matrix corresponding to the first activation tensor static.
13. The one or more non-transitory, computer-readable media of clauses 11 or 12, wherein the first activation tensor is identified by executing the trained machine learning model on training data.
14. The one or more non-transitory, computer-readable media of any of clauses 11-13, wherein the trained machine learning model comprises a large language model.
15. The one or more non-transitory, computer-readable media of any of clauses 11-14, wherein the trained machine learning model comprises N layers, and further comprising presenting an output tensor generated using an Nth-1 layer included in the trained machine learning model as an activation tensor to the Nth layer included in the machine learning model, compressing the activation tensor using a projection matrix that corresponds to the Nth layer of the trained machine learning model to produce a compressed activation tensor, and generating an output tensor by multiplying the compressed activation tensor and a pre-computed weight matrix that corresponds to the Nth layer of the trained machine learning model, wherein the output tensor comprises the output data generated for the trained machine learning model.
16. The one or more non-transitory, computer-readable media of any of clauses 11-15, wherein the output data generated for the trained machine learning model comprises natural language text, structured text, or computer code.
17. The one or more non-transitory, computer-readable media of any of clauses 11-16, wherein the first pre-computed weight matrix is computed by multiplying the first projection matrix and a retrained corresponding weight matrix.
18. The one or more non-transitory, computer-readable media of any of clauses 11-17, wherein each eigenvector derived from an estimated autocorrelation matrix comprises a different column of the first projection matrix.
19. The one or more non-transitory, computer-readable media of any of clauses 11-18, wherein compressing the first activation tensor comprises multiplying a transpose of the first projection matrix and the first activation tensor, and wherein multiplying the compressed first activation tensor and the first pre-computed weight matrix comprises multiplying the transpose of the first projection matrix and the first pre-computed weight matrix to generate an intermediate matrix, and multiplying a transpose of the first intermediate matrix and the compressed first activation tensor.
20. In some embodiments, a system comprises one or more memories including instructions, and one or more processors that are coupled to the one or more memories and, when executing the instructions, are configured to perform the steps of presenting input data as a first activation tensor to a first layer of a trained machine learning model, compressing the first activation tensor using a first projection matrix that corresponds to the first layer of the trained machine learning model to produce a compressed first activation tensor, generating a first output tensor by multiplying the compressed first activation tensor and a first pre-computed weight matrix that corresponds to the first layer of the trained machine learning model, presenting the first output tensor as a second activation tensor to a second layer of the trained machine learning model, compressing the second activation tensor using a second projection matrix that corresponds to the second layer of the trained machine learning model to produce a compressed second activation tensor, generating a second output tensor by multiplying the compressed second activation tensor and a second pre-computed weight matrix that corresponds to the second layer of the trained machine learning model, and generating output data for the trained machine learning model based on the second output tensor.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for executing trained machine learning models, the method comprising:
presenting input data as a first activation tensor to a first layer of a trained machine learning model;
compressing the first activation tensor using a first projection matrix that corresponds to the first layer of the trained machine learning model to produce a compressed first activation tensor;
generating a first output tensor by multiplying the compressed first activation tensor and a first pre-computed weight matrix that corresponds to the first layer of the trained machine learning model;
presenting the first output tensor as a second activation tensor to a second layer of the trained machine learning model;
compressing the second activation tensor using a second projection matrix that corresponds to the second layer of the trained machine learning model to produce a compressed second activation tensor;
generating a second output tensor by multiplying the compressed second activation tensor and a second pre-computed weight matrix that corresponds to the second layer of the trained machine learning model; and
generating output data for the trained machine learning model based on the second output tensor.

2. The computer-implemented method of claim 1, wherein the trained machine learning model comprises a retrained compressed machine learning model.

3. The computer-implemented method of claim 2, wherein the retrained compressed machine learning model is retrained by at least retraining a weight matrix corresponding to a first activation tensor associated with the trained machine learning model while keeping a projection matrix corresponding to the first activation tensor static.

4. The computer-implemented method of claim 1, wherein the trained machine learning model comprises N layers, and further comprising:
presenting an output tensor generated using an Nth−1 layer included in the trained machine learning model as an activation tensor to the Nth layer included in the machine learning model;
compressing the activation tensor using a projection matrix that corresponds to the Nth layer of the trained machine learning model to produce a compressed activation tensor; and
generating an output tensor by multiplying the compressed activation tensor and a pre-computed weight matrix that corresponds to the Nth layer of the trained machine learning model;
wherein the output tensor comprises the output data generated for the trained machine learning model.

5. The computer-implemented method of claim 1, wherein the output data generated for the trained machine learning model comprises natural language text, structured text, or computer code.

6. The computer-implemented method of claim 1, wherein the first projection matrix, the second projection matrix, the first pre-computed weight matrix, and the second pre-computed weight matrix are accessible from a data store.

7. The computer-implemented method of claim 1, wherein the first pre-computed weight matrix is computed by multiplying the first projection matrix and a retrained corresponding weight matrix.

8. The computer-implemented method of claim 1, wherein the first projection matrix is generated based on a plurality of eigenvalues derived from an estimated autocorrelation matrix.

9. The computer-implemented method of claim 8, wherein the estimated autocorrelation matrix is computed by averaging a plurality of autocorrelation matrices.

10. The computer-implemented method of claim 1, wherein compressing the first activation tensor comprises multiplying a transpose of the first projection matrix and the first activation tensor, and wherein multiplying the compressed first activation tensor and the first pre-computed weight matrix comprises multiplying the transpose of the first projection matrix and the first pre-computed weight matrix to generate an intermediate matrix, and multiplying a transpose of the first intermediate matrix and the compressed first activation tensor.

11. One or more non-transitory, computer-readable media including instructions that, when executed by one or more processors, cause the one or more processors to perform the steps of:
presenting input data as a first activation tensor to a first layer of a trained machine learning model;
compressing the first activation tensor using a first projection matrix that corresponds to the first layer of the trained machine learning model to produce a compressed first activation tensor;
generating a first output tensor by multiplying the compressed first activation tensor and a first pre-computed weight matrix that corresponds to the first layer of the trained machine learning model;
presenting the first output tensor as a second activation tensor to a second layer of the trained machine learning model;
compressing the second activation tensor using a second projection matrix that corresponds to the second layer of the trained machine learning model to produce a compressed second activation tensor;
generating a second output tensor by multiplying the compressed second activation tensor and a second pre-computed weight matrix that corresponds to the second layer of the trained machine learning model; and
generating output data for the trained machine learning model based on the second output tensor.

12. The one or more non-transitory, computer-readable media of claim 11, wherein the trained machine learning model comprises a retrained compressed machine learning model, and wherein the retrained compressed machine learning model is retrained by at least retraining a weight matrix corresponding to a first activation tensor associated with the trained machine learning model while keeping a projection matrix corresponding to the first activation tensor static.

13. The one or more non-transitory, computer-readable media of claim 11, wherein the first activation tensor is identified by executing the trained machine learning model on training data.

14. The one or more non-transitory, computer-readable media of claim 11, wherein the trained machine learning model comprises a large language model.

15. The one or more non-transitory, computer-readable media of claim 11, wherein the trained machine learning model comprises N layers, and further comprising:
presenting an output tensor generated using an Nth-1 layer included in the trained machine learning model as an activation tensor to the Nth layer included in the machine learning model;
compressing the activation tensor using a projection matrix that corresponds to the Nth layer of the trained machine learning model to produce a compressed activation tensor; and
generating an output tensor by multiplying the compressed activation tensor and a pre-computed weight matrix that corresponds to the Nth layer of the trained machine learning model;
wherein the output tensor comprises the output data generated for the trained machine learning model.

16. The one or more non-transitory, computer-readable media of claim 11, wherein the output data generated for the trained machine learning model comprises natural language text, structured text, or computer code.

17. The one or more non-transitory, computer-readable media of claim 11, wherein the first pre-computed weight matrix is computed by multiplying the first projection matrix and a retrained corresponding weight matrix.

18. The one or more non-transitory, computer-readable media of claim 11, wherein each eigenvector derived from an estimated autocorrelation matrix comprises a different column of the first projection matrix.

19. The one or more non-transitory, computer-readable media of claim 11, wherein compressing the first activation tensor comprises multiplying a transpose of the first projection matrix and the first activation tensor, and wherein multiplying the compressed first activation tensor and the first pre-computed weight matrix comprises multiplying the transpose of the first projection matrix and the first pre-computed weight matrix to generate an intermediate matrix, and multiplying a transpose of the first intermediate matrix and the compressed first activation tensor.

20. A system, comprising:
one or more memories including instructions; and
one or more processors that are coupled to the one or more memories and, when executing the instructions, are configured to perform the steps of:
presenting input data as a first activation tensor to a first layer of a trained machine learning model;
compressing the first activation tensor using a first projection matrix that corresponds to the first layer of the trained machine learning model to produce a compressed first activation tensor;
generating a first output tensor by multiplying the compressed first activation tensor and a first pre-computed weight matrix that corresponds to the first layer of the trained machine learning model;
presenting the first output tensor as a second activation tensor to a second layer of the trained machine learning model;
compressing the second activation tensor using a second projection matrix that corresponds to the second layer of the trained machine learning model to produce a compressed second activation tensor;
generating a second output tensor by multiplying the compressed second activation tensor and a second pre-computed weight matrix that corresponds to the second layer of the trained machine learning model; and
generating output data for the trained machine learning model based on the second output tensor.
